(19) United States
(12) Patent Application Publication
(10) Pub. No.: US 2023/0226850 A1
(43) Pub. Date: Jul. 20, 2023

(54) Hub for a Bicycle Wheel, Bicycle Drive System, and Bicycle

(71) Applicant: Jenny und Frank Sportartikelhandel GbR, Murr (DE)

(72) Inventor: Christian Jenny, Backnang (DE)

(21) Appl. No.: 17/998,325

(22) PCT Filed: May 11, 2021
(86) PCT No.: PCT/DE2021/100431

§ 371 Date: Nov. 9, 2022

(30) Foreign Application Priority Data
May 12, 2020 (DE) 10 2020 112 889.4

(51) Int. Cl. B60B 27/02; B62M 1/38; B62M 6/55

(52) U.S. Cl. CPC B60B 27/023; B62M 1/38; B62M 6/55

(57) ABSTRACT

The disclosure refers to a hub for a bicycle running wheel, a bicycle drive system and a bicycle. In an embodiment a hub for a bicycle running wheel includes a hub body and a receiving area configured to receive a force transmission means, wherein the hub body and the receiving area are a single part or are firmly connected together.

This patent application is a national phase filing under section 371 of PCT/EP2021/100431, filed May 11, 2021, which claims the priority of German patent application 10 2020 112 889.4, filed May 12, 2020, each of which is incorporated herein by reference in its entirety.

### TECHNICAL FIELD

The present invention relates to a hub for a bicycle wheel, a bicycle drive system comprising such a hub, and a bicycle comprising such a drive system.

The hub according to the invention generally relates to a hub for a drivable running wheel of a bicycle. Preferably, this is a rear wheel hub.

The hub according to the invention is particularly suitable for bicycles wherein the pedal force of the user is assisted using an electric carry-on motor including a rechargeable battery (so-called pedelec, e-bike). However, the hub may also be used in a purely muscle-driven bicycle.

### BACKGROUND

In the prior art, hubs are known comprising a hub body that co-rotates with the running wheel. For example, the hub is driven via the pedal cranks and a chainring of the bottom bracket via a drive means (in particular a chain), namely via a force transmission means on the hub. As a force transmission means, so-called cassettes (pinion packages) are particularly widely in use, currently in an arrangement of up to 12 or even more. The pinion package is driven by a rear derailleur known per se. The force transmission means is seated on a freewheel body of the hub. The freewheel body is formed separately from the hub body. A so-called freewheel operates between the hub body and the freewheel body, which freewheel engages in the presence of a pedaling movement, thus transmit-ting the pedaling force via the force transmission means to the hub and thus to the driven running wheel

However, if the user does not perform any pedaling motion, engagement of the freewheel is released, so that the pedal crank without load does not necessarily co-rotate with the rear wheel hub. In the freewheel, for example, a ratchet system or a pair of axially acting spur toothing acting against each other under spring tension may be realized. In this regard, the person skilled in the art will recognize a wide variety of configurations.

Prior art hubs comprising a hub body and a separate receiving area for a force transmission means, in particular with a freewheel operating therebetween, on the one hand, are of heavy weight and, on the other hand, are expensive and complicated to manufacture. Two opposing rolling bearings are generally provided. The receiving area for the force transmission means (namely the freewheel body), is to be mounted separately and thus generally requires additional roller bearings.

The freewheel is subject to wear due to the permanent sliding of toothing elements against each other. Internal friction always exists, at the expense of kinetic energy. Furthermore, such a hub requires regular maintenance.

Since an above-mentioned prior art hub, together with a derailleur, can only be shifted while pedaling, this especially will pose problems to inexperienced users during the shifting operation. Often, shifting is done under too much load. This problem is further aggravated when used in pedelecs or e-bikes, where an additional motor considerably increases the load acting on the chain.

### SUMMARY

Embodiments overcome the disadvantages known from prior art.

Further embodiments provide a hub for a bicycle running wheel which is simple and inexpensive to manufacture, and having minimum mass, which is low in maintenance or is maintenance-free, which has improved running properties, and which makes it easier for the user to use his bicycle. In this context, a suitable bicycle drive system and a bicycle is also provided.

A hub for a bicycle running wheel according to the invention, a bicycle drive system as well as a bicycle, which at least will achieve one of the objectives indicated above, are disclosed within the scope of the independent claims.

Advantageous embodiments and further developments of the invention are the subject-matter of the dependent claims.

A hub according to the invention for a bicycle running wheel according to claim 1 comprises a hub body as well as a receiving area for a force transmission means, wherein the hub body and the receiving area are manufactured from one part or are rigidly connected together.

In particular, no freewheel is arranged or realized between the hub body and the receiving area.

The force transmission means may in particular comprise a cassette (pinion package) or a belt pulley.

A composite or an article comprising a hub body as well as a receiving area for a force transmission means, namely for a hub according to the invention, having the features of claim 17 will be disclosed.

A bicycle drive system according to claim 6 comprises a hub according to the invention, which is arranged in a drivable running wheel of a bicycle and comprises a force transmission means arranged on the receiving area thereof, which force transmission means can be driven via a drive means by a drive formed in the region of the bottom bracket of the bicycle, wherein a freewheel between the drive means and the drive is realized in the bottom bracket region of the bicycle.

A bicycle according to claim 16 comprises a bicycle drive system according to the invention.

The drive means may in particular comprise a chain or a belt.

The freewheel may be realized in particular between the pedal crank and the chainring of the drive, in the electric motor of the drive, or in the transmission of the drive.

Preferably, the invention integrally combines a hub including a hub body and a receiving area with a conventional cassette receiving area. Thus, the hub according to the invention is compatible with commercially available cassettes. The hub does not have a freewheel in the hub, this can preferably be realized in the crank, or directly in the motor or in the gearbox, of the drive. This allows the drive means, in particular a chain, to run permanently during the ride, and thus it is possible to shift gears without pedaling and also without load on the drive train (in particular chain or belt).

Still more specifically or additionally, the invention provides at least one of the advantages mentioned below:
fewer individual parts, cheaper to manufacture, fewer rolling bearings, less material, opening up of new markets possible because of cost effective mass-producibility
cheaper and lighter product
less wear, no wear because there is no freewheel
faster, easier and less dangerous replacement of the force transmission means, as it does not have to be secured against twisting with a chain whip when loosening the chain.
ecologically advantageous due to fewer parts and simpler manufacture
fewer rolling bearings to be maintained
practically no maintenance required, thus less expensive to maintain
can be shifted while driving without pedaling
significantly less wear on the drive means such as chain and the force transmission means such as pinion, since shifting can be performed without load. This brings enormous advantages for pedelecs, e-bikes and other electric-assisted bicycles, as well as for conventional bicycles, preferably in combination with an integrated freewheel in the crank, gearbox or motor.
less friction due to fewer rolling bearings
less strain within the rolling bearings due to concentricity, which can be produced more precisely, resulting in even less friction and less wear of the rolling bearings
better smooth running
significantly stiffer, since rolling bearings are realized which are positioned further outside than with conventional hubs. This results in a significantly lower bending load on the axle and therefore a thinner axle can be used, which provides additional weight benefits.

In particular, ball bearings are used as rolling bearings in the present application.

In the following, the aspects according to the invention will further be discussed, for which purpose reference will partially be made to the non-limiting advantageous embodiments and further developments of the invention. The features of advantageous further developments may be realized individually or may also be realized in any combination, thus creating further advantageous embodiments of the invention.

In the hub for a bicycle running wheel according to the invention, the hub body and the receiving area are preferably made from a single part. In particular, the integral article comprising the hub body and the receiving area may be milled from a solid part.

If the hub body and the receiving area are provided from different parts, they can rigidly be connected to form a hub according to the invention, in particular by screwing or welding.

Preferably, no freewheel is arranged or realized between the hub body and the receiving area.

The receiving area for the force transmission means preferably has a receiving area for a cassette (pinion package), a belt pulley or a pinion.

The receiving area for the force transmission means can have an external thread on its circumference for fixing the force transmission means (in particular a cassette). The cassette preferably has an inner sleeve extending to the outside of the smallest pinion, which is screwed onto the thread of the receiving area from the smallest pinion using a suitable nut, wherein the matching inner profile of the cassette travels across the receiving profile of the receiving area of the cassette, thus producing a form fit between the cassette and the receiving area in the circumferential direction so as to transmit force. Such fixations for cassettes are known per se.

The receiving area for the force transmission means can alternatively have a receiving profile substantially extending to the outer end of the receiving area, onto which receiving profile a force transmission means a cassette) may slidingly be placed. Subsequently, the cassette may be fixed with an end nut which engages in an internal thread of the essentially cylindrical receiving area. A driving force may then be transmitted in the circumferential direction via the receiving area profile and the corresponding inner profile of the cassette. Such fixations for cassettes are known per se.

In particular, the hub according to the invention does not provide a freewheel. In this respect, it is advantageous to implement a freewheel between the drive means (in particular chain or belt) and the drive of the bicycle in the region of the drive, in particular in the bottom bracket region of the bicycle, as part of a drive system for a bicycle. This means that the pedal crank and/or electric motor do not rotate when the bicycle currently is not being driven and is merely rolling (pushing mode).

The drive is preferably located in the region of the bottom bracket of the bicycle and can comprise a pedal crank with at least one chainring (or pulley) for driving the drive means, and/or an electric motor.

The freewheel can preferably be realized between the pedal crank and the chainring or belt pulley. In particular, the freewheel can be realized directly between the pedal crank and the chainring, between the pedal crank and the pedal bearing shaft, or between the pedal bearing shaft and the chainring.

Alternatively, a freewheel can be provided in the electric motor. Alternatively, a freewheel can be realized in a transmission associated with the drive, in particular the electric motor.

In an advantageous embodiment, the drive system is arranged such that in the pushing mode the electric motor can be driven by the drive means driven by the rotating hub. In this case, the electric motor can act as a generator in the context of recuperation so that it can recharge an accumulator associated with the electric motor.

Recuperation operation is particularly useful for long downhill runs or frequent stops, e.g. in city traffic. In this way, kinetic energy that is otherwise converted into thermal energy during braking and thus will be lost, can be used to recharge the accumulator and thus significantly increase the electric cruising range.

Preferably, the presence and/or the strength of a recuperation can be selected or adjusted by a user. On the one hand, the recuperation mode can preferably be fully engaged or disengaged as desired in order not to experience any increased resistance when pedaling or pushing. Alternatively or additionally, the strength of the recuperation can be adjusted by the user.

For this purpose, a control element can be provided, which in particular can be located on the handlebar of the bicycle. Particularly preferably, the operation of a recuperation mode can be integrated into a anyways present computer or control unit of a pedelec/e-bike.

### BRIEF DESCRIPTION OF THE DRAWINGS

Supplementary or additional to the advantageous embodiments and further developments of the teachings already discussed, examples embodiments of devices according to the invention shown in the drawing in the scope of FIGS. 1 to 4 are explained in more detail. However, the examples discussed by making reference to the drawing do not limit the invention to the examples shown. In discussing the examples embodiments by making reference to the drawing, preferred embodiments and further developments of the technical teachings will also be shown in general.

Further developments of the above-described advantageous embodiments having the features of the following examples embodiments expressly constitute further advantageous embodiments of the invention, just as further developments of the below-described examples embodiments having the features of the above-described embodiments expressly constitute further advantageous embodiments of the invention, thus form part of the present disclosure.

With respect to the following illustration of the figures, it should be pointed out in general that reference numbers already shown in previous figures and already explained in this respect above, have not fully been adopted in the subsequent figures for reasons of clarity and/or are not explained again in some cases based on the subsequent figures. For illustrating such reference numbers and the associated technical features, reference is made to the respective description of the respective preceding figures in its entirety to avoid repetition, wherein:

FIG. 1 is a lateral view of a preferred example embodiment of the hub for a bicycle running wheel according to the invention;

FIG. 2 is a sectional view of the hub of FIG. 1, as seen from above along the sectional plane H-H of FIG. 1;

FIG. 3 is a perspective view of the hub of FIGS. 1 and 2; and

FIG. 4 is a partially schematic lateral representation of a preferred example embodiment of a bicycle according to the invention, which simultaneously comprises a preferred example embodiment of a bicycle drive system according to the invention.

### DETAILED DESCRIPTION OF ILLUSTRATIVE EMBODIMENTS

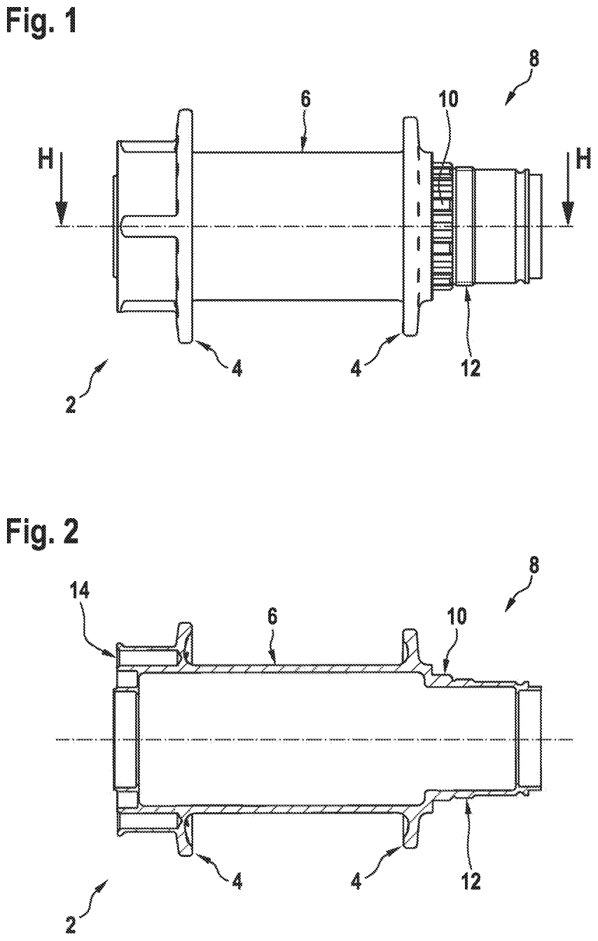

FIG. 1 shows a preferred example embodiment of the hub 2 according to the invention for a bicycle running wheel in a lateral view. The example shown is a rear wheel hub. The hub 2 is viewed from behind in the direction of travel of the bicycle.

The hub 2 comprises a left and a right spoke flange 4. The region to the left of the right spoke flange 4 may be designated as the hub body 6. The region to the right of this may be designated as receiving area 8 for a power transmission means (not shown herein), in this case a pinion package (cassette).

While departing from the known state of the art, the hub body 6 and the receiving area 8 are made of one part. Alternatively, these regions could be rigidly connected together, e.g. by welding or screwing.

Thus, no freewheel is arranged or realized between the hub body 6 and the receiving area 8. Nevertheless, the hub 2 has a receiving area 8 for a power transmission means, in particular a cassette or a belt pulley.

The receiving area 8 comprises on the left a receiving profile 10 for the torque transmission from the force transmission means, and on the right thereof an external thread 12 for fixing the force transmission means.

The force transmission means, in this case a cassette (not shown herein), has an inner sleeve extending to the outside of the smallest pinion, which is screwed onto the external thread 12 of the receiving area 8 from the smallest pinion using a suitable nut. In the process, the matching inner profile of the cassette travels across the receiving profile 10 of the receiving area 8, creating a form fit between the cassette and the receiving area 8 in the circumferential direction and allowing force to be transmitted. Such a system for fixing a cassette and for transmitting torque from a cassette to a hub 2 is known from the company SRAM® under the designation XD®.

FIG. 2 shows a sectional view of the hub 2 of FIG. 1 seen from above along the sectional plane H-H of FIG. 1. It becomes clear that the hub body 6 and the receiving area 8 here consist of or are manufactured from one part. For example, the composite or the object consisting of hub body 6 and receiving area 8 can be milled of one solid part, preferably of aluminum or titanium.

In this illustration, the spoke flanges 2 and the disc brake mount 14 are also shown.

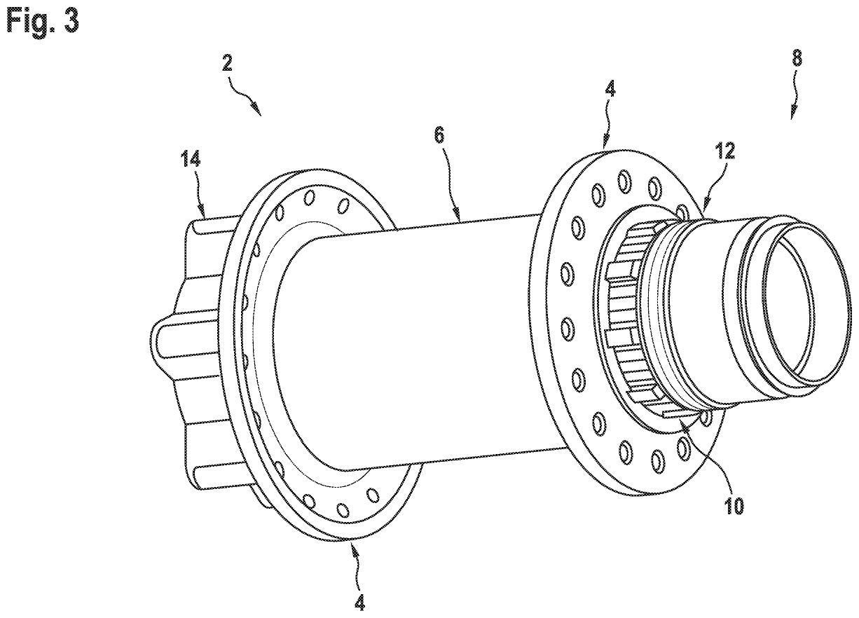

FIG. 3 shows a perspective view of the hub 2 from FIGS. 1 and 2 and illustrates that the assembly of hub body 6 and receiving area 8 is hollow on the inside. Due to the one-part design of the composite and the omission of the freewheel, the hub 2 can be made with the smallest possible wall thickness, and thus the lowest possible weight while at the same time providing considerable rigidity.

Furthermore, the external thread 12, the mounting profile 10, the spoke flanges 2 and the disc brake mount 14 are shown in more detail in this illustration.

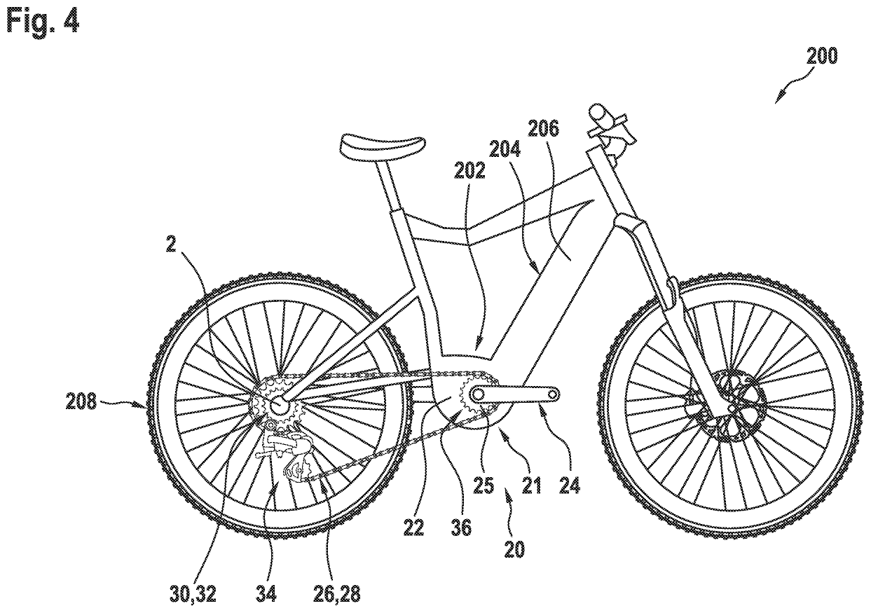

FIG. 4 shows a partially schematic lateral view of a preferred example embodiment of a bicycle 200 according to the invention, which simultaneously comprises a preferred example embodiment of a bicycle drive system 20 according to the invention.

What is shown is a bicycle 200 as a pedelec/e-bike in an embodiment as a mountain bike. The drive system 20 initially comprises a drive 21 in the bottom bracket region 202 of the bicycle 200. The drive 21 initially comprises an electric motor 22 integrated in the bottom bracket region 202, which is fed by an accumulator 206 integrated in the down tube 204. Furthermore, in addition to the electric motor 22, the drive 21 comprises a pedal crank 24 with a chainring 25. Depending on the operating state, the pedal crank 24, together with the electric motor 22, drives the force transmission means 30 (herein cassette 32) arranged on the hub 2, namely on the rear wheel hub, and thus the rear running wheel 208 of the bicycle 200, via a drive means 26 (chain 28). The cassette 32 can be shifted via the derailleur system 34 of a chain derailleur.

The bicycle drive system 20 according to the invention comprises a hub 2 according to the invention (as shown in FIGS. 1 to 3) arranged in the drivable running wheel 208 (here the rear wheel) of the bicycle 200 without freewheel. The force transmission means 30 (cassette 32) is arranged on the receiving area 8 (not to be seen in FIG. 3) of the hub 2, which can be driven via the drive means 26 (chain 28) by the drive 21 formed in the bottom bracket region 202 of the bicycle.

A freewheel 36 is realized between drive means 26 and drive 21 in the bottom bracket area 202 of the bicycle 200. The freewheel 36 can be realized in particular between the pedal crank 24 and the chainring 25 of the drive 21, in the electric motor 22 of the drive 21, or in a transmission of the drive 21.

Since the hub 2 (rear wheel hub) does not have a freewheel, the chain 28 is always moved further even during free rolling (pushing mode). The freewheel 36 realized in the bottom bracket area 202 prevents a forced co-movement of the cranks 24. The derailleur system 34 can thus also be operated without any pedaling movement—and thus may be operated completely load-free—as long as the bicycle 200 is rolling. As a result, maloperation, in particular shifting under too much load, can be avoided.

Furthermore, the drive system 21 can be arranged such that, in the pushing mode, the electric motor 22 can be driven by the drive means 26 driven by the hub 2 which continues to rotate as a result of the pedaling motion. In this case, the electric motor 21 can act as a generator during recuperation and can recharge the accumulator 206.

Here, the freewheel 36 may preferably be realized between the pedal crank 24 and the chainring 25.

Although the invention has been illustrated and described in detail by means of the preferred embodiment examples, the present invention is not restricted by the disclosed examples and other variations may be derived by the skilled person without exceeding the scope of protection of the invention.

### EMBODIMENTS

In addition to the advantageous embodiments, further embodiments and examples embodiments already discussed, the invention will be described below while making reference to other preferred specific embodiments which, however, do not limit the invention to the embodiments described. These embodiments are expressly part of the present description.

Further embodiments of the above-described advantageous embodiments and examples embodiments having the features of the following embodiments expressly form further advantageous embodiments of the invention, just as further embodiments of the below-described embodiments having the features of the above-described embodiments and examples embodiments, and are thus within the scope of the present disclosure.

Embodiment 1: A hub for a bicycle running wheel, comprising a hub body and a receiving area for a force transmission means, wherein the hub body and the receiving area are made of one part.

Embodiment 2: The hub according to the preceding embodiment, wherein the hub body and the receiving area are milled together of one part.

Embodiment 3: A hub for a bicycle running wheel, comprising a hub body and a receiving area for a force transmission means, wherein the hub body and the receiving area are rigidly connected together.

Embodiment 4: The hub for a bicycle running wheel, optionally according to one of the preceding embodiments, comprising a hub body as well as a receiving area for a force transmission means, wherein no freewheel is arranged or realized between the hub body and the receiving area.

Embodiment 5: The hub according to at least one of the preceding embodiments, wherein the force transmission means comprises a cassette (pinion package), a belt pulley or a pinion.

Embodiment 6: The hub according to at least one of the preceding embodiments, wherein the receiving area comprises a receiving profile and/or an external thread for receiving and/or fixing the force transmission means.

Embodiment 7: A bicycle drive system, comprising a hub arranged in a drivable running wheel of a bicycle according to at least one of the preceding embodiments, having a force transmission means arranged on the receiving area of the hub, which force transmission means can be driven via a drive means by a drive formed in the region of the bottom bracket of the bicycle, wherein a freewheel is realized in the bottom bracket region of the bicycle between the drive means and the drive.

Embodiment 8: The bicycle drive system according to the preceding embodiment, wherein the drive comprises a pedal crank including chainring or belt pulley, and optionally an electric motor.

Embodiment 9: The bicycle drive system according to at least one of the preceding embodiments 7 or 8, wherein the drive means comprises a chain or a belt.

Embodiment 10: The bicycle drive system according to at least one of the preceding embodiments 7 to 9, wherein the freewheel is realized between the pedal crank and the chainring or between the pedal crank and the belt pulley of the drive.

Embodiment 11: The bicycle drive system according to at least one of the preceding embodiments 7 to 9, wherein the freewheel is realized in the electric motor of the drive.

Embodiment 12: The bicycle drive system according to at least one of the preceding embodiments 7 to 9, wherein the freewheel is realized in a transmission of the drive.

Embodiment 13: The bicycle comprising a bicycle drive system according to at least one of the preceding embodiments 7 to 12.

Embodiment 14: Assembly or article comprising a hub body and a receiving area for a force transmission means, namely for a hub according to at least one of the preceding embodiments 1 to 6.

1.-17. (canceled)

18. A hub for a bicycle running wheel, the hub comprising:
a hub body; and
a receiving area configured to receive a force transmission means,
wherein the hub body and the receiving area are a single part or are firmly connected together.

19. The hub according to claim 18, wherein the hub body and the receiving area are milled together from the single part.

20. The hub according to claim 18, wherein no freewheel is arranged or realized between the hub body and the receiving area.

21. The hub according to claim 18, wherein the receiving area is a receiving area configured to receive a cassette, a belt pulley or a pinion.

22. The hub according to claim 18, wherein the receiving area has a receiving profile and/or an external thread configured to receive and/or fix the force transmission means.

23. A bicycle drive system comprising:
the hub according to claim 18 arranged in the bicycle running wheel;
the force transmission means arranged on the receiving area of the hub;
a drive means; and
a drive arranged in a bottom bracket region,
wherein the force transmission means is drivable via the drive means by the drive, and
wherein a freewheel is arranged in the bottom bracket region between the drive means and the drive.

24. The bicycle drive system according to claim 23, wherein the force transmission means comprises a cassette or a belt pulley.

25. The bicycle drive system according to claim 23, wherein the drive comprises a pedal crank including a chainring or a belt pulley.

26. The bicycle drive system according to claim 25, wherein the freewheel is arranged between the pedal crank and the chainring.

27. The bicycle drive system according to claim 25, wherein the freewheel is arranged between the pedal crank and the belt pulley.

28. The bicycle drive system according to claim 25, wherein the drive further comprises an electric motor.

29. The bicycle drive system according to claim 28, wherein the bicycle drive system is arranged such that the electric motor is drivable by the drive means driven by the rotating hub and such that the electric motor acts as a generator during recuperation thereby recharging an accumulator assigned to the electric motor.

30. The bicycle drive system according to claim 29, wherein a presence and/or a strength of the recuperation is selectable or adjustable by a user.

31. The bicycle drive system according to claim 28, wherein the electric motor is configured to act as a generator when the electric motor is driven by the rotating hub via the drive means during recuperation.

32. The bicycle drive system according to claim 28, wherein the freewheel is arranged in the electric motor of the drive.

33. The bicycle drive system according to claim 23, wherein the drive means comprises a chain or a belt.

34. The bicycle drive system according to claim 23, wherein the freewheel is arranged in a transmission of the drive.

35. A bicycle comprising:
the bicycle drive system according to claim 23.
